(19) United States
(12) Patent Application Publication
(10) Pub. No.: US 2013/0243423 A1
(43) Pub. Date: Sep. 19, 2013

(54) ETHERNET HUB AND METHOD OF USE

(71) Applicant: Ziqiang He, Danville, CA (US)

(72) Inventor: Ziqiang He, Danville, CA (US)

(21) Appl. No.: 13/558,324

(22) Filed: Jul. 25, 2012

Related U.S. Application Data
(60) Provisional application No. 61/511,882, filed on Jul. 26, 2011.

(51) Int. Cl. H04L 12/26

(52) U.S. Cl. CPC H04L 43/50
USPC 398/33; 370/246; 370/250

(57) ABSTRACT

A new and improved Ethernet hub for providing visibility of data packet traffic in an Ethernet network is disclosed. The Ethernet hub includes a packet buffer being coupled with a plurality of network ports to enable full duplex data packet communications among connected network stations.

### CROSS-REFERENCE TO RELATED APPLICATIONS

This application claims priority from Provisional Application No. 61511882, filed Jul. 26, 2011.

### FIELD OF THE INVENTION

This invention relates generally to data communication devices. More particularly, this invention is related to a new and improved Ethernet hub to enable monitoring of data packet traffic in an Ethernet network.

### BACKGROUND OF THE INVENTION

Ethernet hubs are perhaps the oldest the networking devices for connecting multiple network stations such as personal computers in a local area network (LAN) to facilitate data communications among the connected network stations. FIG. 1 is a block diagram in which an Ethernet hub 100 with three network ports 140 to provide network connections to three computers 120. Although only the 3-port Ethernet hub 100 is described, it can be realized that an Ethernet hub in general can have more than three network ports. Technically, the Ethernet hub 100 is a relatively unsophisticated device which just “broadcasts” any data packets it receives from each of its connected computer 120 to all the other connected computers 120. As shown in FIG. 1, each computer 120 connects to the Ethernet hub 100 by a copper twisted-pair cable 130 (e.g. Category 5 cable) which includes a transmit pair 131 and receive pair 132. The Ethernet hub 100 acts as a shared bus 110 to electrically deliver signals carrying Ethernet data packets from one computer 120 to the other two computers 120. At any time when one computer 120 is transmitting its data packets to another connected computer 120 over the shared bus 110, the transmitter 121 of the transmitting computer 120 takes the “ownership” of the shared bus 110 by transmitting signals along the shared bus 110 during which the transmitters 121 of the other two computers 120 are not allowed to transmit signals, the other two computers 120 can only “listen to” the signals being transmitted on the shared bus 110 via the respective receivers 122.

As can be seen, Ethernet hubs as networking devices present the following drawbacks and limitations:
Ethernet hubs can only operate in half duplex mode. At any time only a single computer can transmit signals. If two or more connected computers are trying to send data packets via an Ethernet hub at the same time, collision would occur and corrupt the signals being transmitted. In other words, Ethernet hubs do not support full duplex communications which is much more desirable in increasing the efficiency of the data communications.
Ethernet hubs are limited to operate on copper cables such as twisted pair cables like Category 5 network cables or the like; they do not support optical fiber connections.
Ethernet hubs are limited to lower Ethernet data rate because of the signal transmission limitation of the shared signal bus. Traditional Ethernet hubs are seen only capable of operating at date rate of 10 Mbps or 100 Mbps; they are not able to operate at higher Ethernet date rate such as 1 Gbps (1000 Mbps) and 10 Gbps.

With the advent of Ethernet switches that basically overcome the drawbacks of Ethernet hubs as described above, Ethernet hubs are rarely used today for networking computers and other network stations in a local area network. However, because an Ethernet hub always broadcasts data packets received on each network port to all the other network ports over the shared bus, it provides a simple packet sniffing capability which enables a connected computer to receive (listen to) all the data packets being transmitted from any other computers connected to the same Ethernet hub, an Ethernet hub is still often used today by IT professionals as an inline sniffing device to capture and monitor data packet traffic in an Ethernet network.

Therefore, what is needed is an improved Ethernet hub such that the above discussed problems and limitations can be resolved while the data packet sniffing capability is still kept.

### BRIEF DESCRIPTION OF THE DRAWINGS

The foregoing and other features, aspects and advantages of the invention will become more apparent from the following detailed description when read in conjunction with the following drawings, in which,

FIG. 1 is a block diagram of an Ethernet hub of priori art which connects three computers for communicating data packets over a shared bus.

FIG. 2 is a block diagram of an Ethernet hub in accordance with the present invention in which a packet buffer memory is included.

FIG. 3 is a block diagram of an Ethernet hub in accordance with an embodiment of the present invention which provides two aggregation monitor ports for use as an inline packet sniffing device.

FIG. 4 is a block diagram of an Ethernet hub in accordance with another embodiment of present invention which provides both an aggregation monitor port and two separate non-aggregation monitor ports for use as an inline packet sniffing device.

FIG. 5 is a block diagram of an Ethernet hub in accordance with the present invention which automatically configures either two copper network ports or two optical network ports as two inline ports depending on the presence status of a pluggable optical transceiver module connectable to one of the two optical network ports.

FIG. 6 is a detailed circuit schematic view of generating the presence signal of a pluggable transceiver module connectable to one selected optical port in the Ethernet hub in FIG. 5.

### DETAILED DESCRIPTION OF THE INVENTION

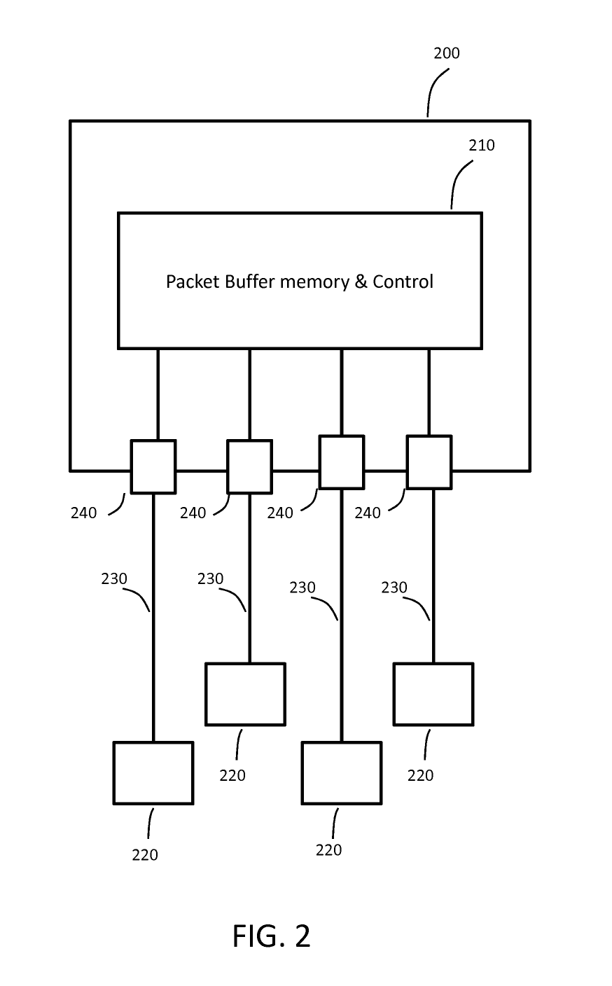

FIG. 2 shows an Ethernet hub 200 in accordance with the present invention which has four network ports 240 each connectable to a computer 220 (or other type of network station) by a network cable 230.

It should be noted that the 4-port Ethernet hub in FIG. 2 is depicted for the purpose of reducing the complexity of the illustration; an Ethernet hub in accordance with the present invention can have more than four network ports.

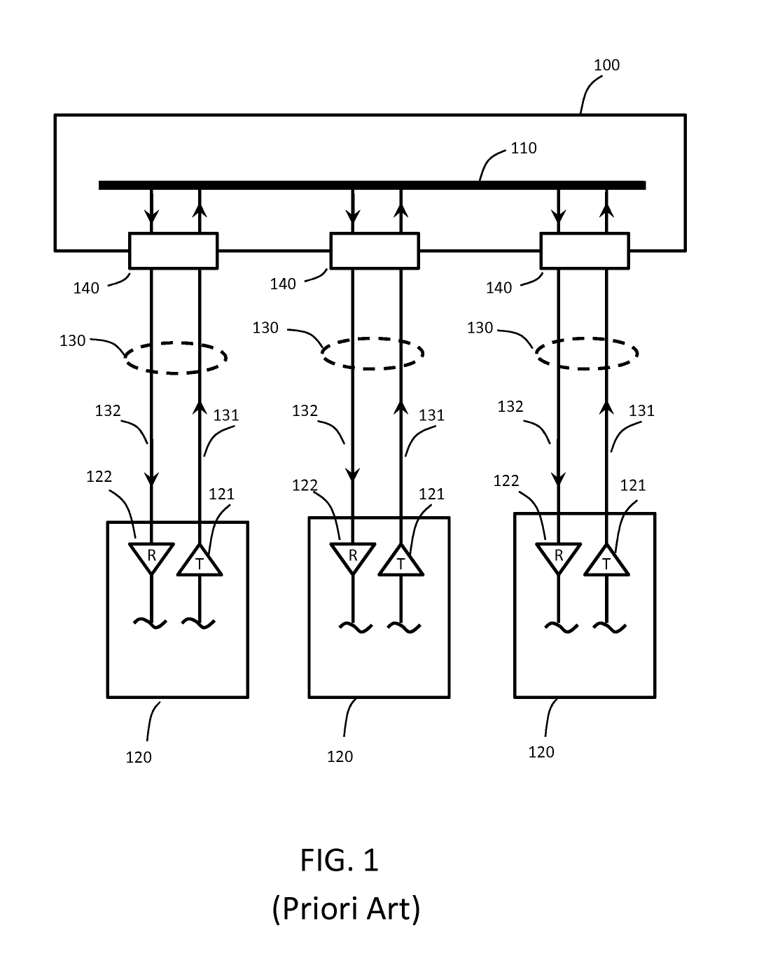

In accordance with the present invention, the improved Ethernet hub 200 as shown in FIG. 2 is implemented with a packet buffer memory 210. When the Ethernet hub 200 receives data packets from any of the four network ports 240, the received data packets are temporally stored in the packet buffer memory 210; at the same time each of the data packets previously stored in the packet buffer memory 210 is read out in a first-in-first-out approach and is forwarded to all the other network ports except the network port from which the data packet is originally received. In other words, instead of broadcasting received data packets over a shared signal bus to all connected computers 120 as the traditional Ethernet hub 100 in FIG. 1 does, the Ethernet hub 200 in FIG. 2 performs a store-and-broadcast operation to each of the received data packets by means of the packet buffer memory 210.

The operations of the packet buffer memory 210 is controlled by the associated control circuitry which is responsible for both writing ingress data packets from each of the network ports 240 of the Ethernet hub 200 into the packet buffer memory 210 and reading each of the stored data packets from the packet buffer memory 210 which is then forwarded as an egress data packet to the other respective network ports 240. An ingress data packet refers to an incoming data packet a network port 240 receives from an externally connected computer 220, and an egress data packet refers to an outgoing data packet that is to be sent out from the network port 240 to the externally connected computer 220.

In accordance with an embodiment of the present invention, under the operations of the packet buffer memory control circuitry, ingress data packets will be discarded when the packet buffer memory 210 becomes full and is not able to accept more ingress data packets until the packet buffer memory 210 becomes available again as the result of the previously stored data packets being read out. An egress data packet may also be discarded at a network port 240 when the network port 240 becomes over-subscribed in which the total throughput of egress data packets is more than the bandwidth of the network port 240 can accommodate for. For instance, for a network port 240 operating at the date rate of 100 Mbps, when the total throughput of egress data packets toward the network port 240 is more than 100 Mbps, the network port 240 becomes over-subscribed and will drop the otherwise outgoing data packets.

Because of data packet buffering provided by the packet buffer memory 210, each network port 240 of the Ethernet hub 200 of the present invention is able to send and receive data packets simultaneously to and from the connected computer 220 without causing signal collisions. In other words, the Ethernet hub 200 in FIG. 2 enables full-duplex communications among the connected computers 220.

Preferably, the network port 240 of the Ethernet hub 200 can be implemented with a multi-speed Ethernet PHY ASIC (Application Specific Integrated Circuit) chip such as the 10/100/1000base-T Ethernet PHY 88E1111 from Marvell Technology Group Ltd to support Gigabit Ethernet connection. Higher data rate such as 10 Gbps connection is also possible with a 10G PHY ASIC chip.

Alternatively, a selected network port 240 of the Ethernet hub 200 can be implemented with an optical/electrical transceiver to send and receive data packets to and from the connected computer 220 over an optical cable 230. The optical/electrical transceiver can be a pluggable module such as the FTLF8519P2xCL made by Finisar Corporation, which is a small form factor pluggable (SFP) optical transceiver module in compliance with an industry standard proposed by MSA (Multiple Source Agreement) Group.

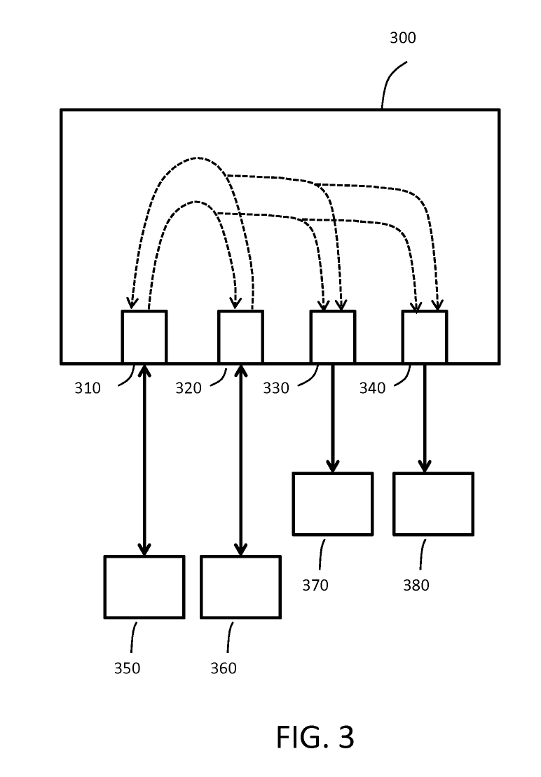

FIG. 3 is a block diagram of an Ethernet hub in accordance with the present invention which provides two monitor ports for use as an inline packet sniffing device. The Ethernet hub 300 in FIG. 3 includes four network ports which are designated as a first inline port 310, a second inline port 320, a first monitor port 330 and a second monitor port 340. The Ethernet hub 300 includes a packet buffer memory which is not shown in FIG. 3 for reducing the complexity of illustration.

In accordance with an embodiment of the present invention, the Ethernet hub 300 is configured in such a way that the ingress data packets of the first inline port 310 are forwarded (broadcasted) to all the other three network ports, i.e., the second inline port 320, the first monitor port 330 and the second monitor port 340 after being stored in the packet buffer memory (not shown in FIG. 3), and the ingress data packets of the second inline port 320 are forwarded to all the other three network ports, i.e., the first inline port 310, the first monitor port 330 and the second monitor port 340 after being stored in the packet buffer memory (not shown in FIG. 3). As such, the Ethernet hub 300 provides a functionality of inline packet sniffing by enabling the passage of full-duplex data packet traffic between the two computers 350 and 360 connected to the first inline port 310 and the second inline port 320 respectively, and at the same time digitally coping the two-way full-duplex data packet traffic to the first monitor port 330 and the second monitor port 340 for output to the two connected computers 370 and 380 respectively. In FIG. 3, both the two computers 370 and 380 are monitoring stations for capturing and analyzing the full-duplex data packet traffic running between two computers 350 and 360 connected by the Ethernet hub 300 placed as an inline device in between the two computers 350 and 360.

Because the output from each of the first and second monitor ports 330 and 340 is a digital copy of data packet traffic that aggregates the two-way full duplex data packet flow between the two inline ports 310 and 320, the first and second monitor ports 330 and 340 are also referred to as aggregation monitor ports respectively.

Optionally, the two aggregation monitor ports 330 and 340 can be configured to discard ingress data packets received by each of the aggregation monitor ports 330 and 340 from the respective connected monitoring stations 370 and 380. This is advantageous in situations where no ingress data packets of a monitor port are allowed to interfere with the data packet traffic traveling between the two inline ports 310 and 320.

As can be seen, there exists situations when the aggregated data throughput of the full-duplex data packet traffic between two inline ports 310 and 320 is more than the bandwidth of each of the aggregation monitor ports 330 and 340 can accommodate. When such situations occur, the otherwise egress data packets will be discarded by the aggregation monitor ports 330 and 340. For example, if the two inline ports 310 and 320 and the two aggregation monitor ports 330 and 340 operate at the same Ethernet date rate of 1 Gbps, the aggregated traffic throughput of the full duplex traffic between the two inline ports 330 and 340 can be as high as 2 Gbps, which will over-subscribe each of aggregation monitor ports 330 and 340, and therefore, the aggregation monitor ports 330 and 340 have to discard egress data packets when over-subscription occurs.

It should be noted that although only two aggregation monitor ports 330 and 340 are depicted in FIG. 3, the Ethernet hub 300 in FIG. 3 can be implemented with a single aggregation monitor port or more than two aggregation monitor ports in accordance with the present invention.

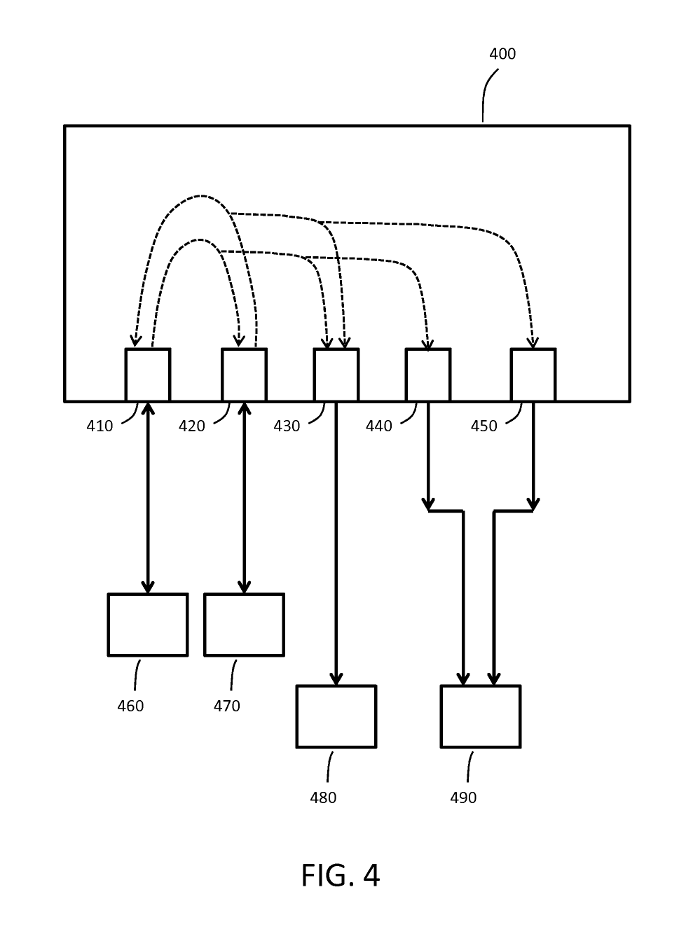

FIG. 4 is a block diagram of an Ethernet hub in accordance with another embodiment of present invention which provides both an aggregation monitor port and two separate non-aggregation monitor ports for use as an inline packet sniffing device. The Ethernet hub 400 in FIG. 4 includes five network ports which are designated as a first inline port 410, a second inline port 420, an aggregation monitor port 430, a first non-aggregation monitor port 440 and a second non-aggregation monitor port 450. In accordance with the embodiment of the present invention, the Ethernet hub 400 operates similarly to the Ethernet hub 300 in FIG. 3 except that the first non-aggregation monitor port 440 is configured to only receive a digital copy of ingress packets from the first inline port 410 and the second non-aggregation monitor port 450 is configured to only receive a digital copy of ingress data packets of the second inline port 420. As such, each of the two non-aggregation monitor ports 440 and 450 receives the data packet traffic between two inline ports 410 and 420 only in one direction, packet drop/loss due to port over-subscription would never occur to the non-aggregation monitor ports 440 and 450. Usually the two non-aggregation monitor ports 440 and 450 must be connected to a monitoring station 490 with two network interfaces which has to run a software program to merge the two individual data packet streams from each of the non-aggregation monitor ports 440 and 450 to establish a digital copy of the full-duplex data packet traffic running between the two network stations 460 and 470 that are connected to the two inline ports 410 and 420 respectively. Therefore, use of the two non-aggregation monitor ports usually is not as convenient as use of an aggregation monitor port for capturing the full-duplex data packet traffic between two inline ports, but it can avoid any packet drop/loss due to port over-subscription.

One main advantage of the Ethernet hub 400 in FIG. 4 in accordance with the present invention is that the Ethernet hub 400 as a single device provides both an aggregation monitor port 430 connectable to a monitoring station 480 and a pair of non-aggregation monitor ports 440 and 450 connectable to the monitoring station 490; a user can thus select which monitor port(s) to use based on the estimated actual throughput of data packet traffic between the two inline ports 410 and 420. The aggregation monitor port 430 is usually used when the inline data packet traffic is light, and the non-aggregation monitor ports 440 and 450 are usually used when the inline data packet traffic is heavy and busy.

Optionally, the aggregation monitor port 430 and the two non-aggregation monitor ports 440 and 450 are configured to discard their respective ingress data packets. This is advantageous in situations where no ingress data packets of a monitor port are allowed to interfere with the data packet traffic between the two inline ports.

In accordance with another embodiment of the present invention, the Ethernet hub 400 in FIG. 4 is replaced with an Ethernet switch with least five network ports which are configured as a first inline port 410, a second inline port 420, an aggregation monitor port 430, a first non-aggregation monitor port 440 and a second non-aggregation monitor port 450. The Ethernet switch 400 receives data packets from each of the network ports, store them in a built-in packet buffer memory and then forward the data packets to their respective destination port or ports based on the header info (i.e., the destination MAC address and source MAC address as specified in the Ethernet standard IEEE 802.3) of each of received data packets. In addition to storing and forwarding data packets as a traditional Ethernet switch does, the Ethernet switch 400 in accordance with the present invention forwards the ingress data packets associated with the first inline port 410 to the second inline port 420, the aggregation monitor port 430 and the first non-aggregation port 440, and forwards the ingress data packets associated with the second inline port 420 to the first inline port 410, the aggregation monitor port 430 and the second non-aggregation monitor port 450. As such, the Ethernet switch 400 in accordance with the embodiment of the invention can be used as both an Ethernet switch and an inline packet sniffing device that is provided with both an aggregation monitor port 430 and a pair of non-aggregation monitor ports 440 and 450.

The forced forwarding of data packets in an Ethernet switch for the purpose of monitoring data packet traffic regardless of the destination MAC address information in the data packets is also referred to as “port mirroring”. The Ethernet switch as described herein provides a novel approach of mirroring data packets to both an aggregation monitor port and a pair of non-aggregation ports by a single device.

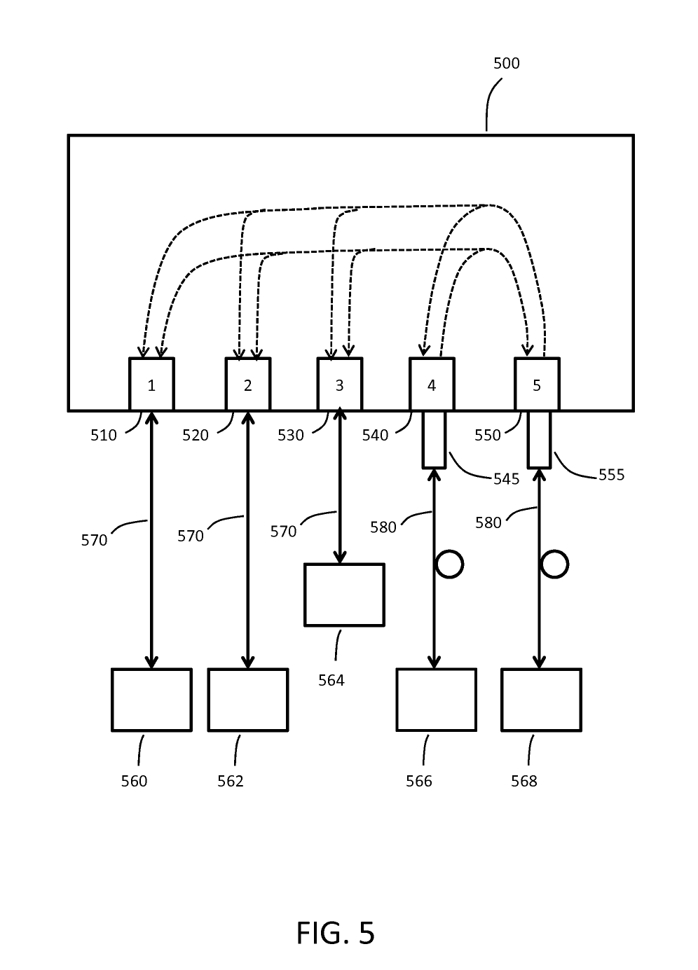

FIG. 5 is a block diagram of an Ethernet hub in accordance with the present invention which includes at least two copper network ports and at least two optical network ports, wherein either a pair of copper network ports or a pair of optical network ports are configured as two inline ports based on the presence status of a pluggable optical transceiver module connectable to one of the optical network ports. As shown in FIG. 5, the Ethernet hub 500 has five network ports including three copper network ports 510, 520 and 530 and two optical network ports 540 and 550 which are connectable to their respective network stations 560, 562, 564, 566 and 568. Each copper network port, typically implemented with an RJ45 jack, sends and receives Ethernet signals (e.g., 10/100/1000Base-T Ethernet) to and from its connected network station over a copper cable 570 of twisted wire pairs (e.g., Cat5e network cable), and each optical network port sends and receives Ethernet signals (e.g. 1000Base-X Ethernet) to and from its connected network station over a optical cable 580 which usually consists at least two optical fibers for full duplex signal transmission. According to the present invention, each of the two optical network ports 540 and 550 on the Ethernet hub is an electrical interface adapted for connecting to a pluggable optical transceiver module (545, 555) which performs the conversions between optical and electrical signals. An example of such a pluggable optical transceiver module is the FTLF8519P2xCL made by Finisar Corporation, which is a small form factor pluggable (SFP) optical transceiver module in compliance with an industry standard specified by the MSA (Multiple Source Agreement) Group.

According to an embodiment of the present invention, the Ethernet hub 500 detects if or not the pluggable optical transceiver module 555 is being connected/engaged with the optical network port 550, and then executes one of two prescribed packet forwarding schemes according to the presence status of the pluggable optical transceiver module. If the optical transceiver module 555 is detected being present on the selected optical network port 550, the two optical network ports 540 and 550 are selected as the two inline ports and therefore the ingress data packets received on each of the optical inline ports 540 and 550 are forwarded (broadcasted) to all the other network ports including the other optical inline port. If the optical transceiver module 555 is not detected being present on the optical network port 550, two selected copper network ports 510 and 520, are configured as the two inline ports and therefore the ingress data packets received on each of the two copper inline ports 510 and 520 are forwarded to all the other network ports including the other copper inline port. In this case, of course, the optical port 550 will not be usable because it is not connected with the pluggable optical transceiver module 555.

According to the present invention, the Ethernet hub 500 configures the packet forwarding scheme from two prescribed packet forwarding schemes after a circuit reset (e.g., a power on reset) to the Ethernet hub 500 based on the presence status of the pluggable optical transceiver module. In other words, a packet forwarding scheme is configured automatically during the initialization process of the Ethernet hub according to the presence status of the pluggable transceiver module after a circuit reset is applied or occurs to the Ethernet hub.

As can be appreciated, the Ethernet hub 500 as depicted in FIG. 5 provides a distinct advantage that the Ethernet hub 500 can be used as an inline packet sniffing device for sniff packets on either a copper connection or an optical connection and the configuration of inline ports from two copper network ports or two optical network ports is automated without the need for a more complicated user command interface like those managed Ethernet switches.

In accordance with another embodiment of the present invention, the Ethernet hub 500 in FIG. 5 is replaced with an Ethernet switch with least five network ports which includes three copper network ports 510, 520 and 530 and two optical network ports 540 and 550. The Ethernet switch 500 detects the presence status of the pluggable optical transceiver module 555 on one selected optical network port 550. If the optical transceiver module 555 is connected on the selected optical network port 550, the selected optical port 550 is configured as the “mirroring from” port and the ingress and egress data packets of the “mirroring from” port network 550 are forwarded (mirrored) to at least one monitor (“mirrored to”) port that is selected from the other network ports (510, 520, 530, 540) not including the “mirroring from” port 550. If the pluggable optical transceiver module 555 is not connected on the selected optical network port 550, a prescribed copper network port is configured as the “mirroring from” port and the ingress and egress data packets of the “mirroring from” port are forwarded (mirrored) to at least one monitor (“mirrored to”) port that is selected from the other network ports not including the prescribed “mirroring from” port. Such an embodiment of the present invention enables the Ethernet switch 500 to support a port mirroring functionality in which the selection of the “mirroring from” port from either a prescribed copper network port or a prescribed optical network port is automated without the need for a more complicated user command interface like those managed Ethernet switches.

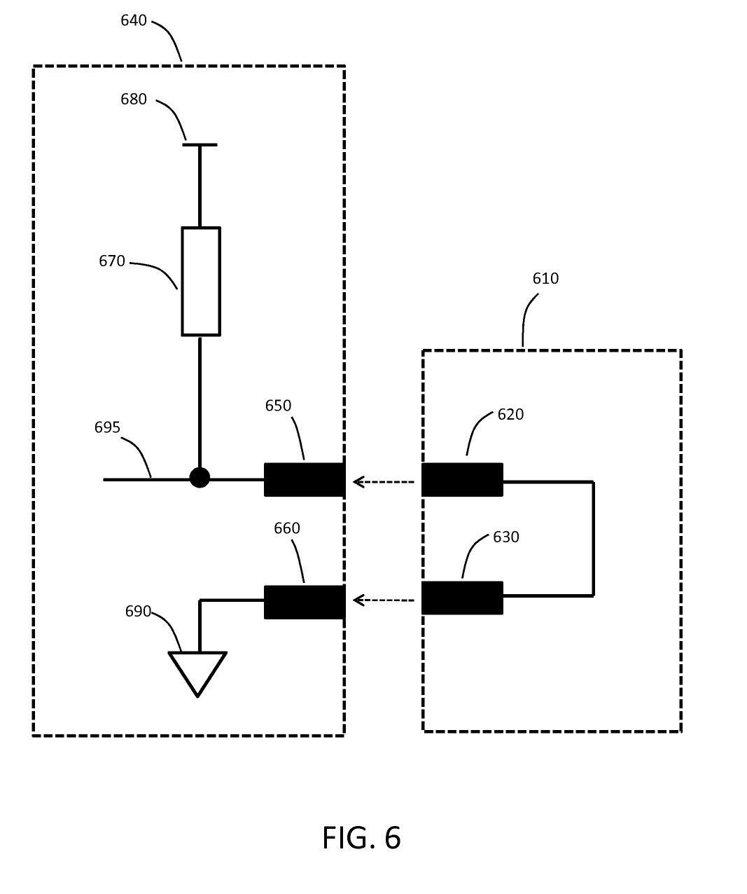

FIG. 6 is a detailed circuit schematic view of generating the presence signal of a pluggable optical transceiver module in one selected optical port in the Ethernet hub or switch in FIG. 5. As shown in FIG. 6, the pluggable optical transceiver module 610 has a presence connector pin 620 and a ground connector pin 630 which are internally wired (electrically shorted) together; the optical port 640 has a corresponding presence connector pin 650 and a corresponding ground connector pin 660; the presence connector pin 650 is connected to an voltage rail 680 (e.g., +3.3V) via a pull-up resistor 670 (e.g., a 4K7 ohm resistor) and the ground connector pin 660 is connected to the ground 690. When the optical transceiver module 610 is not engaged with the optical port 640, the presence signal 695 is pulled up to the voltage level of the power rail 680, representing a logic “High”, which indicates that the pluggable optical transceiver module 620 is not connected to the optical port 640. When the pluggable optical transceiver module 610 is engaged with the optical port 640, the corresponding presence connector pin 650 and the ground connector pin 660 on the optical port 640 are electrically connected with the presence connector pin 620 and the ground connector pin 630 on the pluggable optical fiber module 610, which will pull down the presence signal 695 to the voltage level of the ground 690, representing a logic “Low”, which indicates the pluggable optical transceiver module 610 is being connected on the optical port 610.

Although the present invention has been described in terms of various embodiments, it is to be understood that such disclosure is not to be interpreted as limiting. Various changes and modifications will no doubt become apparent to those skilled in the art after reading the above disclosure. Accordingly, it is intended that the appended claims be interpreted as covering all changes and modifications as fall within the true spirit and scope of the invention. As a result, the invention is not limited to the specific examples and illustrations discussed above, but only the following claims and their equivalents.

What is claimed is:

1. An Ethernet hub of monitoring data packet traffic in an Ethernet network, comprising:
a plurality of network ports, each network port capable of communicating data packets in full duplex with a connected network station; and
a packet buffer memory, the packet buffer memory being coupled with the plurality of network ports, wherein ingress data packets received at each network port are stored in the buffer memory and then are broadcast to each of the other network ports.

2. The Ethernet hub of claim 1, wherein the plurality of network ports are capable of operating at gigabit Ethernet date rates.

3. The Ethernet hub of claim 1, wherein the plurality of network ports are capable of sending and receiving data packets over optical cables.

4. The Ethernet hub of claim 1, wherein at least one network port selected from the plurality of network ports is configured to discard the ingress data packets received from the connected network station.

5. The Ethernet hub of claim 4, further comprising a first non-aggregation monitor port configured to output a digital copy of ingress data packets of a first inline port; and a second non-aggregation monitor port configured to output a digital copy of ingress data packets of a second inline port, wherein the first inline port and the second inline port are two different network ports selected from the plurality of network ports.

6. The Ethernet hub of claim 4, further comprising an optical network port connectable to a pluggable optical transceiver module, wherein a packet forwarding scheme is selected from two prescribed packet forwarding schemes according to the presence status of the pluggable optical transceiver on the optical network port.

7. A network device of monitoring data packet traffic in an Ethernet network, comprising:
a plurality of network ports having a first inline port, a second inline port, an aggregation monitor port, a first non-aggregation monitor port and a second non-aggregation monitor port; and
a packet forwarding arrangement coupled with the plurality of network ports to forward ingress data packets among the plurality of network ports, wherein ingress data packets of the first inline port are forwarded to the second inline port, the aggregation monitor port and the first non-aggregation monitor port, and the ingress data packets of the second inline port are forwarded to the first inline port, the aggregation monitor port and the second non-aggregation monitor port.

8. The network device of claim 7, wherein the network device is an Ethernet switch.

9. A network device of monitoring data packet traffic in an Ethernet network, comprising:
a plurality of network ports, each network port sending and receiving data packets to and from a connected network station, the plurality of network ports including an optical network port connectable to a pluggable optical transceiver module;
a circuit for detecting a presence status of the pluggable optical transceiver module on the optical network port; and
a packet forwarding arrangement coupled with the plurality of networks including the optical network port to forward data packets among connected network stations, wherein the packet forwarding arrangement is configured to execute a packet forwarding scheme selected from two prescribed forwarding schemes according to the presence status of the pluggable optical transceiver on the optical network port.

10. The network device of claim 9, wherein the network device is an Ethernet switch.
